(19) United States
(12) Patent Application Publication
(10) Pub. No.: US 2007/0143344 A1
(43) Pub. Date: Jun. 21, 2007

(54) Cache maintenance in a distributed environment with functional mismatches between the cache and cache maintenance

(75) Inventors: Allen William Luniewski, Cupertino, CA (US); Pedro Filipe Meira Morais, Valadares (PT)

Correspondence Address: INTERNATIONAL BUSINESS MACHINES CORP., IP LAW, 555 BAILEY AVENUE, J46/G4, SAN JOSE, CA, 95141, US

(73) Assignee: International Business Machines Corporation

(21) Appl. No.: 11/316,625

(22) Filed: Dec. 15, 2005

(51) Int. Cl. G06F 17/00

(52) U.S. Cl. 707/104.1

(57) ABSTRACT

Various embodiments of a computer-implemented method, system and computer program product maintain a cache in a distributed environment comprising a front-end server and a back-end server. One or more data sources are accessible to the back-end server. The front-end server and the back-end server support a first query language having more functionality than a second query language supported by a replication component. The data of the front-end cache is described at the front-end server using said first query language. A shadow cache that matches the front-end cache is created at the back-end server. The back-end server changes data in the shadow cache in response to changes in at least a portion of the data in one or more data sources. Data is replicated between the shadow cache and the front-end cache. The data that is replicated from the shadow cache to the front-end cache is described using the second query language.

### BACKGROUND OF THE INVENTION

1. Field of the Invention

This invention relates to cache maintenance; and in particular, this invention relates to cache maintenance in a distributed environment with functional mismatches between the cache and cache maintenance.

2. Description of the Related Art

A database management system, also referred to as a database or database server, allows large volumes of data to be stored and accessed efficiently and conveniently in a computer system. In various database management systems, data is stored in database tables which organize the data into rows and columns. FIG. 1 illustrates a table 10 of a database. In the table 10, a row 12, 14 has data in one or more columns 16, 18 and 20. The term “record” is also used to refer to a row of data in a table.

A federated database is a database server, also referred to as a federated database server, which allows data from many data sources to be accessed from, and integrated at, the federated database server. The data sources may be heterogeneous. The data sources may be local to the federated database server. The data sources may also be remote from the federated database server and at different locations. The federated database server receives a query from a client, and accesses the data sources, as needed, to compute the query results, and then return the query results to the client.

A summary table contains data that is computed or aggregated from data in one or more other tables, for example, monthly financial data which is computed from daily financial data in other tables. The summary table is created and described using a query. In particular, the columns, the data types of the columns, and the contents of the summary table are determined and described based on the query. The query typically specifies a computation or aggregation. In some databases, a summary table is implemented as a materialized query table (MQT). An MQT is a table in which its columns and contents are described by a query against one or more tables. The queries which describe the columns and contents of an MQT include, and are not limited to, queries that comprise summaries or aggregations, and alternately those queries may not comprise summaries or aggregations. An MQT may also be referred to as a materialized view. Processing a query which describes an MQT may consume a large amount of processing time.

In order to improve processing times in a distributed database environment, it is desirable to cache data from a data source at the database server that is processing the query. This cache then permits the database server to execute the query without the performance penalty of retrieving the data from the data source.

A cache is typically implemented as a summary table or MQT and will frequently contain a subset, that is, less than all, of the data from one or more of the data sources. This subset is typically specified via a query against the data source. A replication process is typically used to keep the cached data synchronized with the data at the data source. Replication typically operates by taking at least a subset of the data from a designated replication source and copying that data to a designated table, that is, the replication target. The data to replicate is also specified by a query against the data source using the replication process.

A query is typically implemented using the structured query language (SQL). An exemplary SQL query to describe the data of an MQT is shown below:

SELECT e.dept.deptno, AVG ( e.salary) FROM EmployeeTable e
GROUP BY e.dept.deptno
HAVING COUNT(*) > 5 AND e.dept.deptno > 100

The exemplary SQL query above computes the average of the salaries from a table called EmployeeTable. The average of the salaries is an example of aggregated data. An exemplary SQL statement to create an MQT, called Summary_Salary, based on the SQL query above is shown below:

```
CREATE TABLE Summary_Salary AS
      (SELECT e.dept.deptno, AVG ( e.salary) FROM EmployeeTable e
      GROUP BY e.dept.deptno
      HAVING COUNT(*) > 5 AND e.dept.deptno > 100)
```

The query language supported by the database server may have more functionality than the query language supported by replication. In other words, the data in a cache may be described using a more complex query than supported by replication. For example, a user may want to create a summary table or an MQT which contains aggregated data to use as a cache, and the replication process may not support queries which specify aggregated data. In one database environment, the subset of SQL to describe data for an MQT for a database server is a more powerful subset of SQL than the subset of SQL supported by replication. For example, in this database environment, the subset of SQL to describe data for an MQT at the database server supports aggregated data, while the subset of SQL supported by replication does not support aggregated data. In such a database environment, the exemplary query above cannot be used to describe the data to be replicated because of the difference in SQL functionality between the database server and replication. Hence, in this environment, a SQL query to describe the data of an MQT may not be able to be used by replication; and, the data in the cache cannot be maintained using that SQL query for replication. Therefore, there is a need for a technique to maintain a cache in a distributed environment in which there is a functional mismatch between the query language supported by the database server and the query language supported by replication.

### SUMMARY OF THE INVENTION

To overcome the limitations in the prior art described above, and to overcome other limitations that will become apparent upon reading and understanding the present specification, various embodiments of a computer-implemented method, system and computer program product to maintain a cache at a front-end cache server are provided.

In one embodiment, a distributed environment comprises a front-end server and a back-end server. One or more data sources are accessible to the back-end server. The front-end server and the back-end server support a first query language having more functionality than a second query language supported by a replication component. A front-end cache is created at the front-end server. The data of the front-end cache is described using said first query language. A shadow cache that matches the front-end cache is created at the back-end server. The data of the shadow cache is described using said first query language. The back-end server changes data in the shadow cache in response to changes in the data in one or more data sources. The replication component replicates data from the shadow cache to the front-end cache. The data that is replicated from the shadow cache to the front-end cache is described using the second query language.

In another embodiment, a computer program product comprises a computer usable medium having computer usable program code for maintaining a cache in a distributed environment comprising a front-end server and a back-end server. One or more data sources are accessible to the back-end server. The front-end server and the back-end server support a first query language having more functionality than a second query language supported by a replication component. The computer program product comprises computer usable program code for creating a front-end cache at the front-end server. The data of the front-end cache is described using a first query statement of the first query language. The computer program product further comprises computer usable program code for creating a shadow cache that matches the front-end cache on the back-end server. The data of the shadow cache is described using the first query statement. The back-end server changes data in the shadow cache in response to changes in at least a portion of data in the one or more data sources. The computer program product further comprises computer usable program code for configuring the replication component to replicate data from the shadow cache to the front-end cache using a second query statement of the second query language. The second query statement is different from the first query statement.

In yet another embodiment, a system is provided to maintain a cache in a distributed environment comprising a front-end server and a back-end server. One or more data sources are accessible to the back-end server. The front-end server and the back-end server support a first query language having more functionality than a second query language supported by a replication component. The system comprises a front-end cache at the front-end server. Data of the front-end cache is described using the first query language. The system further comprises a shadow cache at the back-end server that matches the front-end cache. The data of the shadow cache is described using said first query language. The back-end server changes data in the shadow cache in response to changes in at least a portion of data in one or more data sources. The system also comprises a replication component that is configured to replicate data from the shadow cache to the front-end cache using the second query language.

In this way, a cache is maintained in a distributed environment in which there is a functional mismatch between the query language of the server and the query language supported by replication.

### BRIEF DESCRIPTION OF THE DRAWINGS

The teachings of the present invention can be readily understood by considering the following description in conjunction with the accompanying drawings, in which:

FIG. 1 depicts an illustrative table;

FIG. 2 depicts a block diagram of an embodiment of a distributed database environment comprising a front-end server computer and a back-end server computer;

FIG. 3 depicts a flowchart of an embodiment of maintaining a front-end caching table at the front-end database server and a shadow caching table at the back-end database server;

FIG. 4 depicts a flowchart of an embodiment of processing a query using the front-end caching table at the front-end database server and the shadow caching table at the back-end database server;

FIG. 5 depicts a block diagram of an embodiment of a distributed database environment comprising a front-end server computer and a plurality of back-end server computers;

FIG. 6 depicts a block diagram of an embodiment of a distributed database system comprising a plurality of front-end server computers and a back-end server computer;

FIG. 7 depicts a block diagram of an embodiment of a distributed database system comprising a plurality of front-end server computers and a plurality of back-end server computers; and

FIG. 8 depicts an illustrative computer system which uses various embodiments of the present invention.

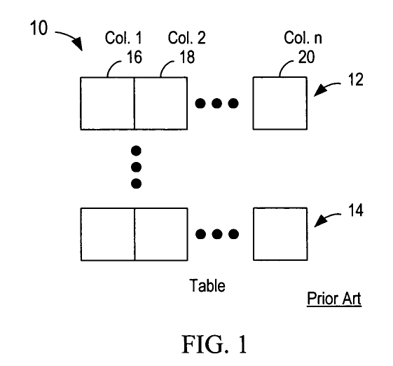

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to maintain a cache in a distributed environment in which there is a functional mismatch between the query language supported by the server and the query language supported by replication. Various embodiments of a computer-implemented method, system and computer program product to maintain a cache at a front-end server are provided.

In one embodiment, a distributed environment comprises a front-end server and a back-end server. One or more data sources are accessible to the back-end server. The front-end server and the back-end server support a first query language having more functionality than a second query language supported by a replication component. A front-end cache is created on the front-end server. The data of the front-end cache is described using the first query language. A shadow cache that matches the front-end cache is created at the back-end server. The data of the shadow cache is described using the first query language. The back-end server changes data in the shadow cache in response to changes in the data from one or more data sources. Data is replicated between the shadow cache and the front-end cache. The data that is replicated from the shadow cache to the front-end cache is described using the second query language.

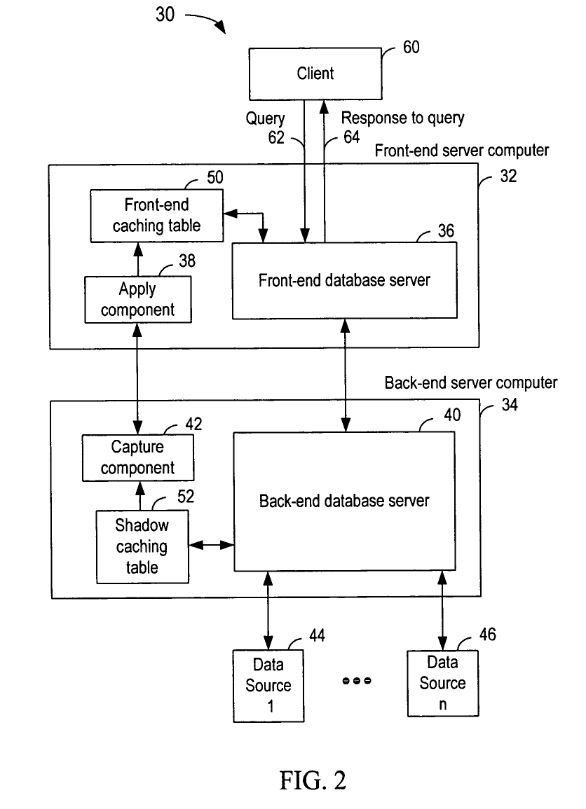

FIG. 2 depicts a block diagram of an embodiment of a distributed database environment 30 comprising a front-end server computer 32 and a back-end server computer 34. The front-end server computer 32 comprises a front-end database server 36 and an apply component 38 of a replication component. In various embodiments, the front-end database server 36 is a federated database server. In some embodiments, the front-end database server 36 is the IBM® (Registered Trademark of International Business Machines Corporation) WebSphere® (Registered Trademark of International Business Machines Corporation) Information Integrator. However, the front-end database server 36 is not meant to be limited to the IBM WebSphere Information Integrator; and in other embodiments, other federated database servers may be used.

To replicate data between two tables, the replication component is configured such that one table is designated as a replication source and another table is designated as a replication target. The replication component replicates data from the replication source to the replication target. The replicated data typically comprises the changes to the replication source. The apply component 38 applies the replicated data to one or more tables which are associated with the front-end database server 36 which are designated as replication targets. For example, in some embodiments the replication component is IBM WebSphere Information Integrator (WebSphere II) Replication Edition. However, the replication component is not meant to be limited to IBM WebSphere Information Integrator (WebSphere II) Replication Edition, and in other embodiments, other replication components may be used.

The back-end server computer 34 comprises a back-end database server 40 and a capture component 42 of the replication component. The capture component 42 at the back-end database server 40 communicates with the apply component 38 at the front-end database server 36 to send replicated data to the apply component 38. In various embodiments, the back-end database server 40 is a relational database. For example, in some embodiments, the back-end database server 40 is the IBM DB2® (Registered Trademark of International Business Machines Corporation) database; however, the back-end database server 40 is not meant to be limited to the IBM DB2 database and other relational databases may be used. In various embodiments, the back-end database server 40 is a federated database. For example, in some embodiments, the back-end database server 40 is IBM WebSphere Information Integrator. However, the back-end database server is not meant to be limited to IBM WebSphere Information Integrator, and other federated databases may be used.

A plurality of data sources, data source 1 44 to data source n 46, are accessible to the back-end database server 40. The data sources 44 to 46 may be heterogeneous. In various embodiments, the data sources 44 to 46 are local to the back-end database server 40, that is, on the same computer system 34 as the back-end database server 40. In some embodiments, at least one of the data sources 44 to 46 is remote, that is, on a different computer system, from the back-end database server 40. The back-end database server 40 is accessible to the front-end database server 36. The data sources 1 44 through n 46 are accessible to the front-end database server 36 through the back-end database server 40. Typically, the data sources 44 through 46 are accessible to the front-end database server 36 via messages which are sent from the front-end database server 36 to the back-end database server 40 which contain queries for the back-end database server 40.

A front-end caching table 50 is created on the front-end server computer 32 using the front-end database server 36. A shadow caching table 52 is created on the back-end server computer 34 using the back-end database server 40. The shadow caching table 52 is created to match the front-end caching table 50. The front-end caching table 50 and the shadow caching table 52 are created using a query on the front-end database server 36 and the back-end database server 40, respectively, which uses features that are not implemented in the replication component.

The front-end server computer 32 is used as a caching node. Replication is used to keep the front-end caching table 50 at the front-end server computer consistent with the shadow caching table 52. The replication component comprises the apply component 38 which is associated with the front-end database server 36 and the capture component 42 which is associated with the back-end database server. The replication component is configured to replicate data from the shadow caching table 52 to the front-end caching table 50. In the replication component, the shadow caching table 52 is designated as the replication source, and the front-end caching table 50 is designated as the replication target. Replication, via the capture and apply components 42 and 38, performs a table-to-table copy of the shadow caching table 52 to the front-end caching table 50, respectively. Replication keeps the front-end caching table 50 up-to-date as changes are made to the shadow caching table 52. Replication is used to access the data, and particularly the changed data of the shadow caching table 52, and propagate that changed data to the front-end caching table 50. Therefore the front-end caching table 50 is consistent with the shadow caching table 52.

By creating the shadow caching table 52 at the back-end database server 40, the inherent capabilities of the back-end database server 40 are used to maintain the consistency of the shadow caching table 52 with the data in the data sources 44 to 46. The back-end database server 40 is configured to keep the shadow caching table 52 consistent with the data sources 44 to 46. In various embodiments, the back-end database server 40 changes the data in the shadow caching table 52 in response to changes to at least a portion of the data in the data sources 44 to 46 which are local to the back-end database server 40. The changes in the data in the data sources 44 to 46 comprise inserting a new row, deleting an existing row, and updating data in an existing row. Therefore, changing the data in the shadow caching table 52 comprises inserting a new row, deleting an existing row, and updating data in an existing row in the shadow caching table 52 in response to changes in that data described by the query which was used to create the shadow caching table 52.

In some embodiments, at least one of the data sources 44 to 46 is remote from the back-end database server 40, and the back-end database server 40 changes the data in the shadow caching table 52 in response to changes in the data in the data sources 44 to 46 which are both local and remote to the back-end database server 40.

Once the shadow caching table 52 is being maintained by the back-end database server 40, replication, using the capture and apply components, 42 and 38, respectively, changes data in the front-end caching table 50 in response to changes in the data in the shadow caching table 52. The capture component 42 at the back-end database server 40 captures the changes to the data in the shadow caching table 52. The changes comprise inserts, deletes and updates. The apply component 38 applies the captured changes to the front-end caching table 50.

A user at a client 60, typically a client process on a client computer system, sends a query 62 to the front-end database server 36. The front-end database server 36 processes the query 62 and returns a response to the client 60. The processing of the query will be described in further detail below with reference to FIG. 4.

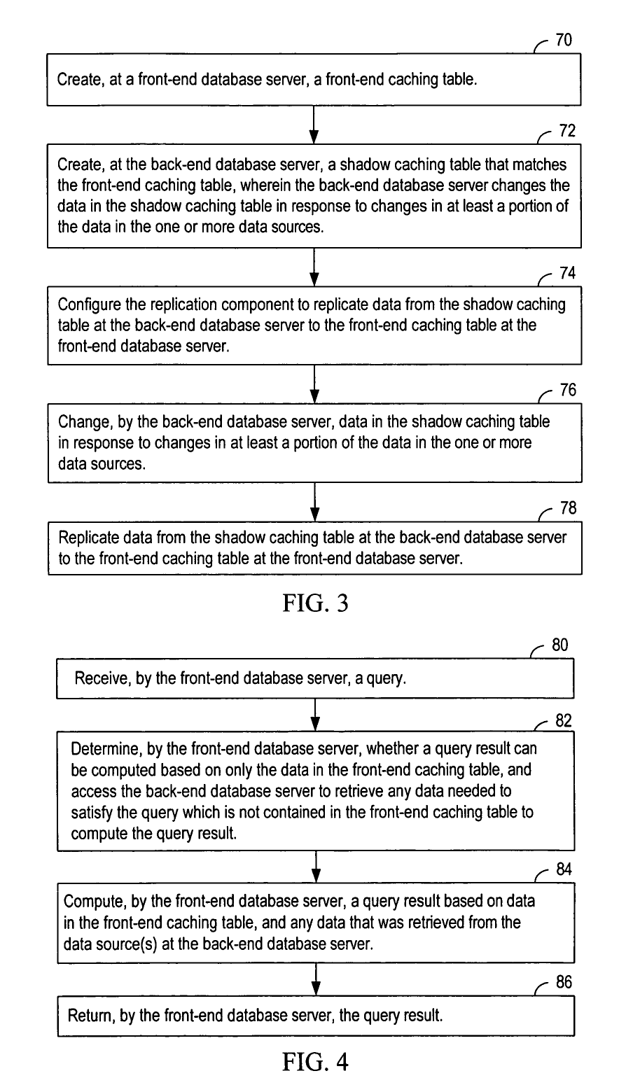

FIG. 3 depicts a flowchart of an embodiment of maintaining a front-end caching table at the front-end database server and a shadow caching table at the back-end database server. In step 70, a front-end caching table is created at a front-end database server. In various embodiments, the front-end caching table is created based on an identified frequently accessed subset of data. In various embodiments, the front-end caching table comprises aggregated data which is based on a subset of data from one or more data sources accessible to the back-end database server.

In step 72, a shadow caching table that matches the front-end caching table, is created at the back-end database server, wherein the back-end database server changes data in the shadow caching table in response to changes in at least a portion of the data from one or more data sources. The shadow caching table matches the front-end caching table. The term “matches” means that the shadow caching table has the same number of columns, the same data type of the columns, and the same position of the columns as the front-end caching table.

In some embodiments, the front-end caching table and the shadow caching tables are MQTs. In other embodiments, the front-end caching table and the shadow caching table are summary tables.

In various embodiments, the back-end database server is configured to change the data in the shadow caching table in response to changes in at least a portion of the data from one or more data sources. In various embodiments using the DB2 database, the SQL statements to create the front-end caching table and the shadow caching table are different, although the same SQL query may be used to describe the front-end caching table and the shadow caching table. Both SQL statements have the same structural information as to the number of columns and data type of the columns. The SQL statement to create the shadow caching table also configures the DB2 database to maintain the shadow caching table such that data in the shadow caching table is changed in response to changes in the data in the data sources thereby providing consistency between the data in the shadow caching table and the data in the data sources. The SQL statement to create the front-end caching table configures the WebSphere Information Integrator database such that an application will use replication so that the front-end caching table is consistent with the shadow caching table. Although various embodiments are described with respect to SQL, the invention is not meant to be limited to SQL and other query languages may be used.

In step 74, the replication component is configured to replicate the shadow caching table at the back-end database server to the front-end caching table at the front-end database server. The shadow caching table is designated as the replication source, and the front-end caching table is designated as the replication target.

In step 76, the back-end database server changes data in the shadow caching table in response to changes in at least a portion of the data in one or more data sources 44 to 46 (FIG. 2). In particular, the back-end database server changes data in the shadow caching table in response to changes in the data in the one or more data sources 44 to 46 (FIG. 2), which is described by the query which was used to create the shadow caching table.

In step 78, data is replicated from the shadow caching table at the back-end database server to the front-end caching table at the front-end database server.

In this way, if the data which is desired to be replicated from a data source at the back-end database server to a front-end caching table at a front-end database server cannot be selected using the SQL functionality provided by the replication component, a shadow caching table which matches the front-end caching table is created and the SQL language of the replication component can be used to replicate data from the shadow caching table to the front-end caching table, for example, as follows:
SELECT*FROM shadowCachingTable.
The exemplary SQL statement above selects all the data from a shadow caching table, called shadowCachingTable, for replication.

Therefore, if an MQT which is a front-end caching table contains aggregated data, and the SQL language supported by the replication component does not provide for aggregated data, the MQT which is the front-end caching table may be kept up-to-data even if it contains aggregated data, because the shadow caching table contains the desired aggregated data, and the SELECT statement to replicate the shadow caching table to the front-end caching table selects the all columns and rows of the shadow caching table for replication, including those columns which contain aggregated data. Hence, the SQL STATEMENT for replication does not have to specify the selection of aggregated data as illustrated above in the exemplary SQL statement in the “Background of the Invention” which specifies the computation of an average.

FIG. 4 depicts a flowchart of an embodiment of processing a query using the front-end caching table at the front-end database server and the shadow caching table at the back-end database server. In step 80, a query is received by the front-end database server.

In step 82, the front-end database server determines whether a query result can be computed based on only the data in the front-end caching table, and accesses the back-end database server to retrieve any data needed to satisfy the query which is not contained in the front-end caching table to compute the query result.

In step 84, compute, by the front-end database server, a query result based on the data in the front-end caching table and any data that was retrieved from the data source(s) of the back-end database server to satisfy the query. Typically, only the data in the front-end caching table is used to compute the query result, and the back-end database server is not accessed. If a portion of the data in the front-end caching table can be used to compute the results of the query, the back-end database server is accessed to retrieve the data not in the front-end caching table from one or more data sources to compute the query result. In step 86, the front-end database server returns the query result.

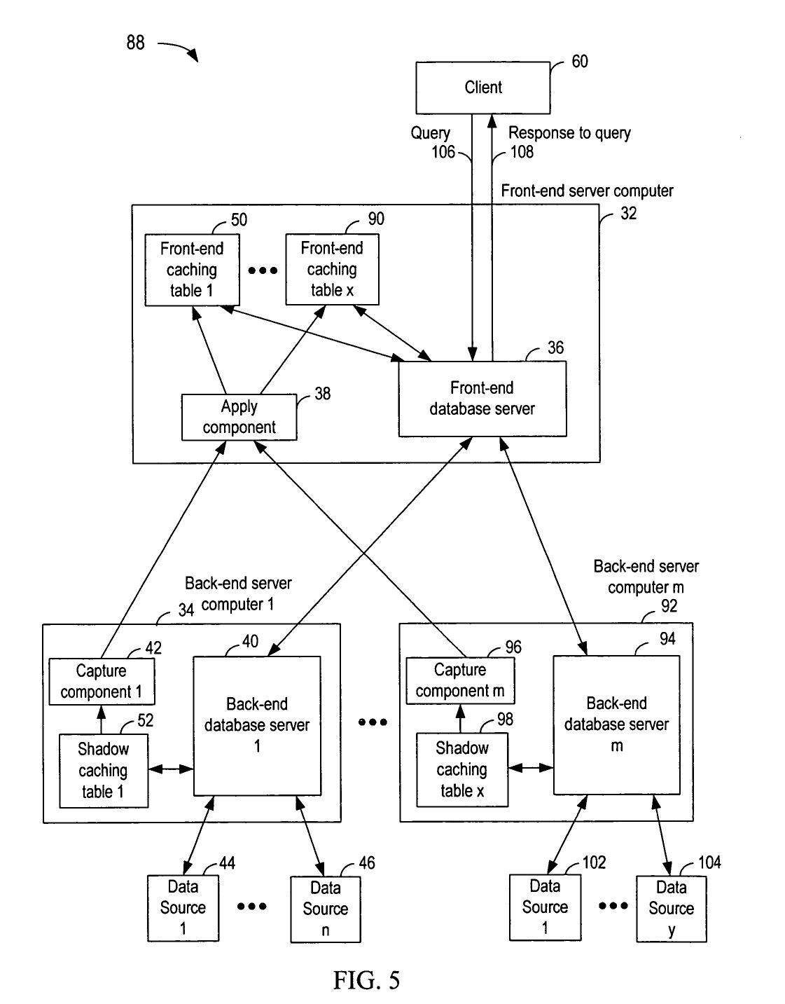

FIG. 5 depicts a block diagram of an embodiment of a distributed database environment 88 comprising a front-end server computer and a plurality of back-end server computers. FIG. 5 comprises the client 60 and the front-end server computer 32 of FIG. 2. In this embodiment, the front-end server computer 32 comprises the front-end database server 36, a replication component comprising an apply component 38, and a plurality of front-end caching tables, front-end caching table 1 50 to front-end caching table x 90. Back-end server computer 1 34 is the same as back-end server computer 34 of FIG. 2, and comprises the back-end database server 40 as back-end database server 1, the replication component comprising a capture component 42 as capture component 1, and shadow caching table 52 as shadow caching table 1. Another back-end server computer, back-end server computer m 92, comprises back-end database server m 94, a replication component comprising a capture component m 96 and a shadow caching table x 98. The shadow caching table x 98 matches the front-end caching table x 90. The number of front-end caching tables is typically the same as the number of shadow caching tables. Data is replicated from the shadow caching table 98 to the front-end caching table 90. A plurality of data sources 102 to 104, are accessible to the back-end database server m 94. The front-end caching table x 90 and the shadow caching table 98 are created as described above with reference to FIG. 3, and used as described above with reference to FIG. 4.

The client 60 sends a query 106 to the front-end database server 36. The front-end database server 36 can access all of the front-end caching tables, 50 to 90, to satisfy the query.

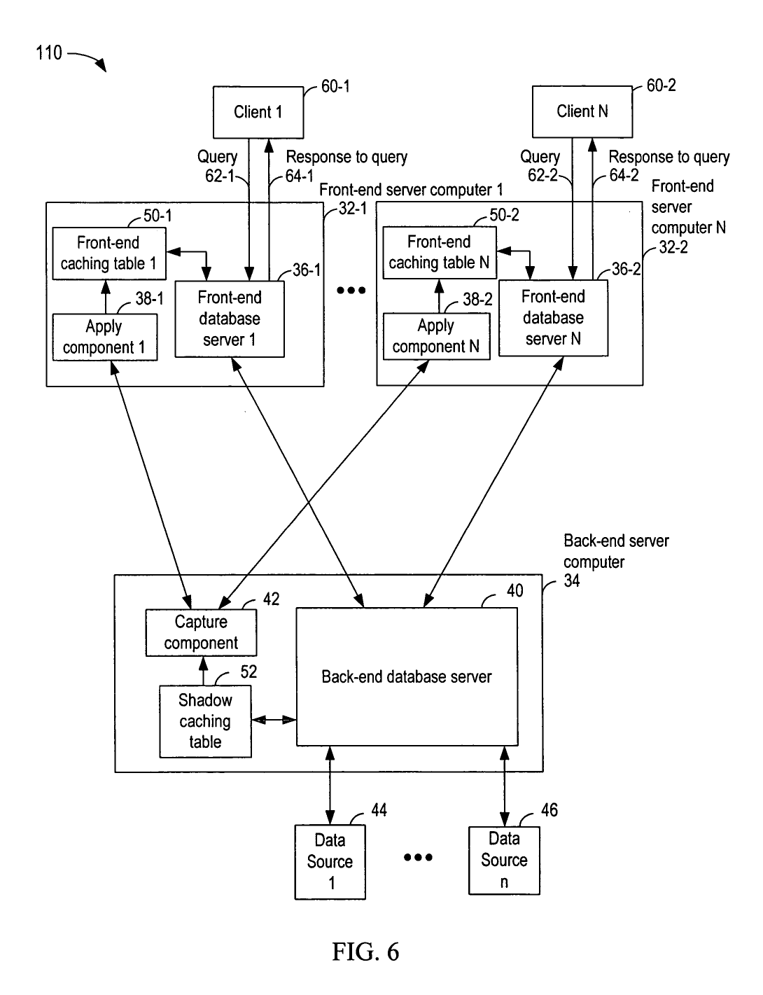

FIG. 6 depicts a block diagram of an embodiment of a distributed database environment 110 comprising a plurality of front-end server computers and a back-end server computer. The distributed database environment 110 of FIG. 6 comprises the back-end server computer 34 of FIG. 2. The back-end server computer 34 comprises the back-end database server 40, the capture component 42, and the shadow caching table 52. Data source 1 44 to data source n 46 are accessible to the back-end database server 40. The distributed database environment 110 of FIG. 6 also comprises front-end server computer 1 32-1 to front-end server computer N 32-2. The front-end server computer 32-1 is the same as the front-end server computer 32 of FIG. 2. The front-end server computers 1 and N, 32-1 and 32-2, comprise front-end database servers 1 and N, 36-1 and 36-2, apply components 1 and N, 38-1 and 38-2, respectively. Exemplary clients 1 and N, 60-1 and 60-2, send queries 62-1 and 62-2 to the front-end database servers 1 and N, 36-1 and 36-2, and receive responses to the queries, 64-1 and 64-2, from the front-end database servers 1 and N, 36-1 and 36-2, respectively. The shadow caching table 52 is replicated to front-end caching tables 50-1 and 50-2.

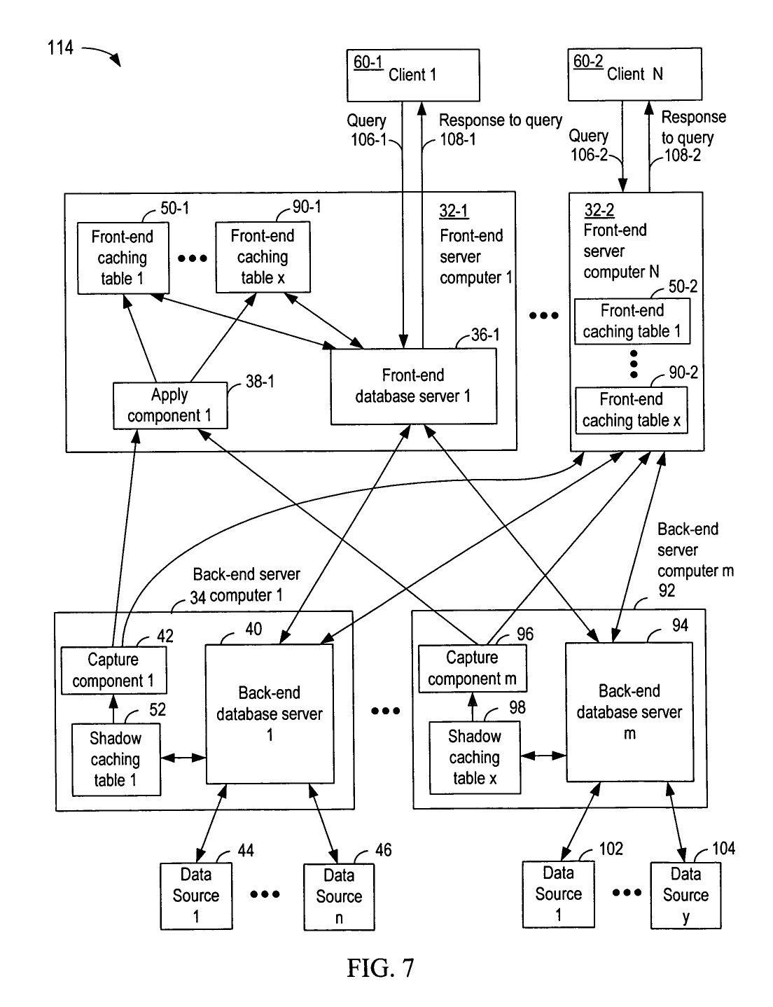

FIG. 7 depicts a block diagram of an embodiment of a distributed database environment 114 comprising a plurality of front-end server computers and a plurality of back-end server computers. The back-end server computers 34 to 92 are the same as in FIG. 5. The back-end server computers 1 and m, 34 and 92, comprise back-end database servers 1 and m, 40 and 94, capture components 42 and 96, and shadow caching tables 1 and x, 52 and 98, respectively. Data source 1 44 to data source n 46 are accessible to back-end database server 1 40. Data source 1 102 to data source y 104 are accessible to back-end database server m 94. The front-end server computer 32-1 has a front-end database server 36, an apply component 38 and front-end caching table 1 50 to front-end caching table x 90. A client 60-1 sends a query 106-1 to the front-end database server 36 and receives a response to the query 108-1 from the front-end database server 36. In this embodiment, there are N front-end server computers. The front-end server computers 32-1 to 32-2 comprise front-end caching tables 1 to x. Front-end server computer N 32-2 comprises a front-end database server, an apply component and the front-end caching tables 1 to x, 116 to 118, respectively. The shadow caching tables 1 and x, 52 and 98 are replicated to the front-end caching table 1, 50 and 116, and the front-end caching table x, 90 and 118, respectively, on the front-end server computers 32. Client N 60-2 sends queries 106-2 to and receives responses 108-2 from the front-end database server in front-end server computer N 32-2.

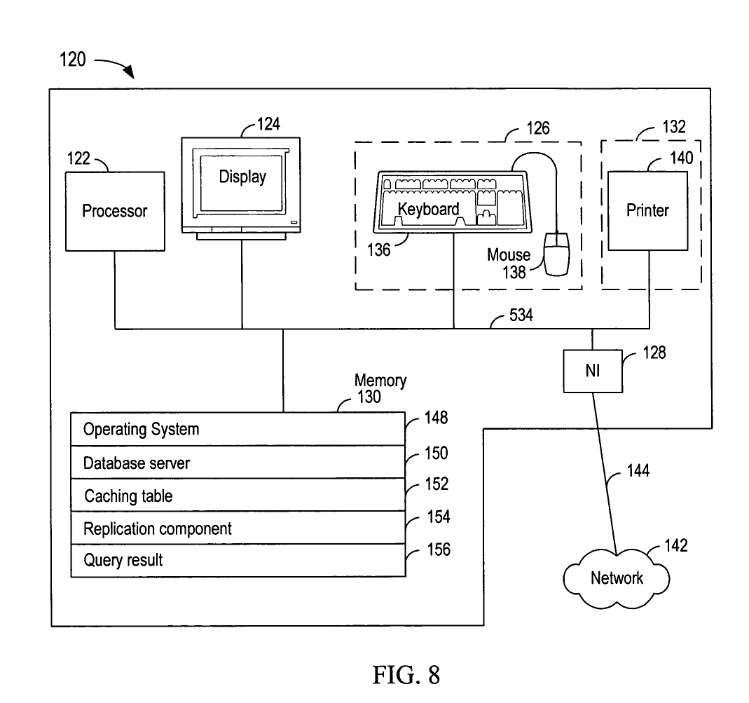

FIG. 8 depicts an illustrative database server computer 120 which uses various embodiments of the present invention. The computer system 120 comprises a processor 122, display 124, input interfaces (I/F) 126, communications interface 128, memory 130 and output interface(s) 132, all conventionally coupled, directly or indirectly, by one or more buses 134. The input interfaces 126 comprise at least one of a keyboard 136 and a pointing device such as a mouse 138. The output interface 132 comprises a printer 140. The communications interface 128 is a network interface (NI) that allows the computer 120 to communicate via a network 142, such as the Internet. The communications interface 128 may be coupled to a transmission medium 144 such as a network transmission line, for example twisted pair, coaxial cable or fiber optic cable. In another embodiment, the communications interface 128 provides a wireless interface, that is, the communications interface 128 uses a wireless transmission medium.

The memory 130 generally comprises different modalities, illustratively volatile memory such as semiconductor memory, such as random access memory (RAM), and persistent or non-volatile memory, such as, disk drives. In some embodiments, the memory 130 comprises local memory which is employed during execution of the program code, bulk storage, and one or more cache memories which provide temporary storage of at least some program code in order to reduce the number of times code is retrieved from bulk storage during execution. In various embodiments, the memory 130 stores an operating system 148, a database server 150, a caching table 152 and a replication component 154. The replication component 154 comprises the apply component, the capture component, or both the apply and capture components. In some embodiments, the database server computer 120 is a front-end database computer, the database server is a front-end database server, and the caching table 152 is a front-end caching table and memory 130 also comprises a query result 156. In other embodiments, the database server computer 120 is a back-end database computer, the database server is a back-end database server, and the caching table 152 is a shadow caching table.

Generally, an embodiment of the present invention is tangibly embodied in a computer-readable medium, for example, the memory 130, and is comprised of instructions which, when executed by the processor 122, causes the database server computer 120 to utilize the present invention. The memory 130 may store the software instructions, data structures and data for any of the operating system 148, the database server 150, the caching table 152 and the replication component 154, in semiconductor memory, in disk memory, or a combination thereof.

The operating system 148 may be implemented by any conventional operating system such as z/OS® (Registered Trademark of International Business Machines Corporation), MVS® (Registered Trademark of International Business Machines Corporation), OS/390® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

In various embodiments in which the computer system 120 is a front-end server computer, the database server 150 is a federated database server as described above. In embodiments in which the computer system 120 is a back-end server computer, the database server 150 is a federated database server, or alternately, a relational database as described above.

In various embodiments, the present invention may be implemented as a method, system, apparatus, computer program product or article of manufacture using standard programming and/or engineering techniques to produce software, firmware, hardware, or any combination thereof. Various embodiments of the invention are implemented in software, which includes and is not limited to firmware, resident software and microcode.

Furthermore various embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable comprise a semiconductor or solid state memory, magnetic tape, a removable computer diskette, a random access memory (RAM), a read-only memory (ROM), a rigid magnetic disk, and an optical disk. Current examples of optical disks comprise compact disk-read only memory (CD-ROM), compact disk-read/write (CD-R/W) and digital video disk (DVD). In addition, the software in which various embodiments are implemented may be accessible through the transmission medium, for example, from a server over the network. The medium also encompasses transmission media, such as the network transmission line and wireless transmission media. Those skilled in the art will recognize that many modifications may be made to this configuration without departing from the scope of the present invention.

The exemplary computer system illustrated in FIG. 8 is not intended to limit the present invention. Other alternative hardware environments may be used without departing from the scope of the present invention.

Various embodiments have been described with respect to a front-end cache and shadow cache that are implemented as tables or MQTs. However, in other embodiments, the front-end cache and shadow cache may be implemented using a structure other than a table or an MQT, for example, an array, spreadsheet, or a flat file.

Various embodiments have also been described with respect to a front-end server and back-end server that are implemented as database servers. However, in other embodiments, the front-end server and the back-end server may be web servers or application servers.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method of maintaining a cache in a distributed environment comprising a front-end server and a back-end server, one or more data sources being accessible to said back-end server, the front-end server and the back-end server supporting a first query language having more functionality than a second query language supported by a replication component, comprising:
creating, at said front-end server, a front-end cache, data of said front-end cache being described using said first query language;
creating, at said back-end server, a shadow cache that matches said front-end cache, data of said shadow cache being described using said first query language;
changing, by said back-end server, data in said shadow cache in response to changes in at least a portion of data in said one or more data sources; and
replicating, by said replication component, data from said shadow cache to said front-end cache, wherein said data that is replicated from said shadow cache to said front-end cache is described using said second query language.

2. The method of claim 1 further comprising:
receiving, by said front-end server, a query; and
computing a query result based on at least a portion of said data in said front-end cache.

3. The method of claim 1 further comprising:
receiving, by said front-end server, a query;
retrieving, by said front-end server, data from said back-end server that is not stored in said front-end cache; and
computing a query result based on said data in said front-end cache and said data retrieved from said back-end server.

4. The method of claim 1 wherein said front-end cache is a materialized query table (MQT) and said shadow cache is an MQT.

5. The method of claim 1 wherein said shadow cache comprises aggregated data based on data in said one or more data sources, and said front-end cache comprises aggregated data.

6. The method of claim 1 wherein said front-end server is a federated database server.

7. The method of claim 1 wherein said back-end server is a relational database.

8. A computer program product comprising a computer usable medium having computer usable program code for maintaining a cache in a distributed environment comprising a front-end server and a back-end server, one or more data sources being accessible to said back-end server, the front-end server and the back-end server supporting a first query language having more functionality than a second query language supported by a replication component, said computer program product comprising:
computer usable program code for creating a front-end cache at said front-end server, data of said front-end cache being described using a first query statement of said first query language;
computer usable program code for creating, at said back-end server, a shadow cache that matches said front-end cache, data of said shadow cache being described using said first query statement, wherein said back-end server changes data in said shadow cache in response to changes in at least a portion of data in said one or more data sources; and
computer usable program code for configuring said replication component to replicate data from said shadow cache to said front-end cache using a second query statement of said second query language different from said first query statement.

9. The computer program product of claim 8 further comprising:
computer usable program code for receiving, by said front-end server, a query; and
computer usable program code for computing a query result based on at least a portion of said data in said front-end cache.

10. The computer program product of claim 8 wherein said first query statement specifies at least one aggregation, and said second query statement selects all data from said shadow cache.

11. The computer program product of claim 8 wherein said front-end cache is a materialized query table (MQT) and said shadow cache is an MQT.

12. The computer program product of claim 8 wherein said shadow cache comprises aggregated data based on data in said one or more data sources, and said front-end cache comprises aggregated data.

13. The computer program product of claim 8 wherein said front-end server is a federated database server.

14. The computer program product of claim 8 wherein said back-end server is a relational database.

15. The computer program product of claim 8 wherein said front-end cache and said shadow cache comprise identified frequently accessed data.

16. A database system to maintain a cache in a distributed environment comprising a front-end server and a back-end server, one or more data sources accessible to said back-end server, the front-end server and the back-end server supporting a first query language having more functionality than a second query language supported by a replication component, comprising:
a front-end cache at said front-end server, wherein data of said front-end cache is described using said first query language;
a shadow cache at said back-end server that matches said front-end cache, wherein data of said shadow cache is described using said first query language, wherein said back-end server changes data in said shadow cache in response to changes in at least a portion of data in said one or more data sources; and
a replication component that is configured to replicate data from said shadow cache to said front-end cache using said second query language.

17. The database system of claim 16 further comprising:
a query received by said front-end server;
a query result computed based on at least a portion of said data in said front-end cache at said front-end server.

18. The database system of claim 16 wherein said front-end cache is a materialized query table (MQT) and said shadow cache is an MQT.

19. The database system of claim 16 wherein said front-end server is a federated database server.

20. The database system of claim 16 wherein said back-end server is a relational database.
